(19) United States
(12) Patent Application Publication
(10) Pub. No.: US 2004/0227123 A1
(43) Pub. Date: Nov. 18, 2004

(54) Fluid selection and redirection valve

(76) Inventors: Paul Justus Rodgers, Reno, NV (US); Thomas L. Peterson, Reno, NV (US); Jan Woody Conover, Sparks, NV (US); Rod Mitchell Walters, Reno, NV (US)

Correspondence Address: BERNHARD KRETEN, ESQ & ASSOCIATES, 1331 GARDEN HIGHWAY, SUITE 300, SACRAMENTO, CA, 95833, US

(21) Appl. No.: 09/874,695

(22) Filed: Jun. 4, 2001

(51) Int. Cl. F16K 5/06

(52) U.S. Cl. 251/315.04

(57) ABSTRACT

A valve for use in harsh chemical environments which is substantially inert from the predations of the chemicals. At least a valve insert is formed from ceramic. The insert defines potential fluid passageways while a gate determines flow path(s).

### FIELD OF THE INVENTION

The following invention is directed to valving used particularly in clinical and analytical laboratories for fluid distribution, for example, in syringe drivers, diluters, dispensers, and sampler valves such as “loop valves” in both automated and manual dispensing systems.

### BACKGROUND OF THE INVENTION

Many scientific laboratories, such as those in research, medical and industrial settings, distribute fluid through valves. Should the fluid react with the valve's components, the process is compromised. Presently, the industry standard requires the valve's gate to be custom made for primarily every job and application.

The following prior art reflects the state of the art of which applicant is aware and is included herewith to discharge applicant's acknowledged duty to disclose the state of the art. It is stipulated, however, that none of these references teach singly nor render obvious when considered in any conceivable combination the nexus of the instant invention as disclosed in greater detail hereinafter and as particularly claimed.

| INVENTOR | PAT. NO. | ISSUE DATE |
|---|---|---|
| Kish, Jr. | 6,149,127 | Nov. 21, 2000 |

### OTHER PRIOR ART REFERENCES

Hamilton Company Brochure “OEM/Industrial Products”, June 1995, entire brochure.

### SUMMARY OF THE INVENTION

The following invention is directed to a valve whose internal moving component which diverts the fluid and seals the valve from leaking is in the form of a fluid passageway insert which is made from a ceramic that is substantially impervious and inert as to a vast, overwhelming majority of fluids. By ceramic it is understood to be a non metallic mineral fired at high temperatures. Such ceramics include the following properties: inertness, resistance to deformation and long wear. The ceramic insert is preferably formed from substantially pure aluminum oxide (90-99.5%) “alumina” mixed with additives required for processing. However, less pure compositions (e.g. 60% aluminum oxide) has utility. Such ceramic is available from Coorstek, Golden Colo. and LTD Ceramic, Newark, Calif. The key to the percentage of aluminum oxide involves the insert's sealing ability versus the resistance to rotating an overlying gate (friction torque).

### OBJECTS OF THE INVENTION

It is a primary object of the present invention to provide an improved valve which is not prone to pitting, galling, seizing, freezing, leaking, etc. in the face of a wide variety of fluids.

A further object of the present invention is to provide a valve as characterized above which is standardized to allow substitution of components from inventory, especially the valve's disc gate and insert which heretofore required custom fabrication for specific jobs and environments.

A further object of the present invention is to provide a valve as characterized above which is particularly tailored to solve chronic, long-standing problems involving valves in the setting of medical, clinical and analytical laboratories, for example.

Viewed from a first vantage point, it is an object of the present invention to provide a valve for use in clinical, analytical or industrial laboratories, comprising, in combination: a housing having fluid inlet means and fluid outlet means, an insert interposed between the fluid inlet means and the fluid outlet means, the insert formed from ceramic material, and means to orient a gate adjacent the insert to control transfer of fluid between the inlet means and the outlet means, the ceramic insert substantially chemically inert to most fluids in the clinical, analytical or industrial laboratory.

These and other objects will be made manifest when considering the following detailed specification when taken in conjunction with the appended drawing figures.

### BRIEF DESCRIPTION OF THE DRAWINGS

FIG. 1 is an exploded parts perspective of the valve in one form.

FIG. 2 is an exploded parts perspective of the valve in a second form.

FIGS. 3A and 3B show variations in housing, insert and disc gate geometry to provide differing flow configurations.

FIG. 4 is a block diagram of the valve in one typical environment.

### DESCRIPTION OF PREFERRED EMBODIMENTS

Considering the drawings, wherein like reference numerals denote like parts throughout the various drawing figures, reference numeral 20 is directed to the valve according to the present invention.

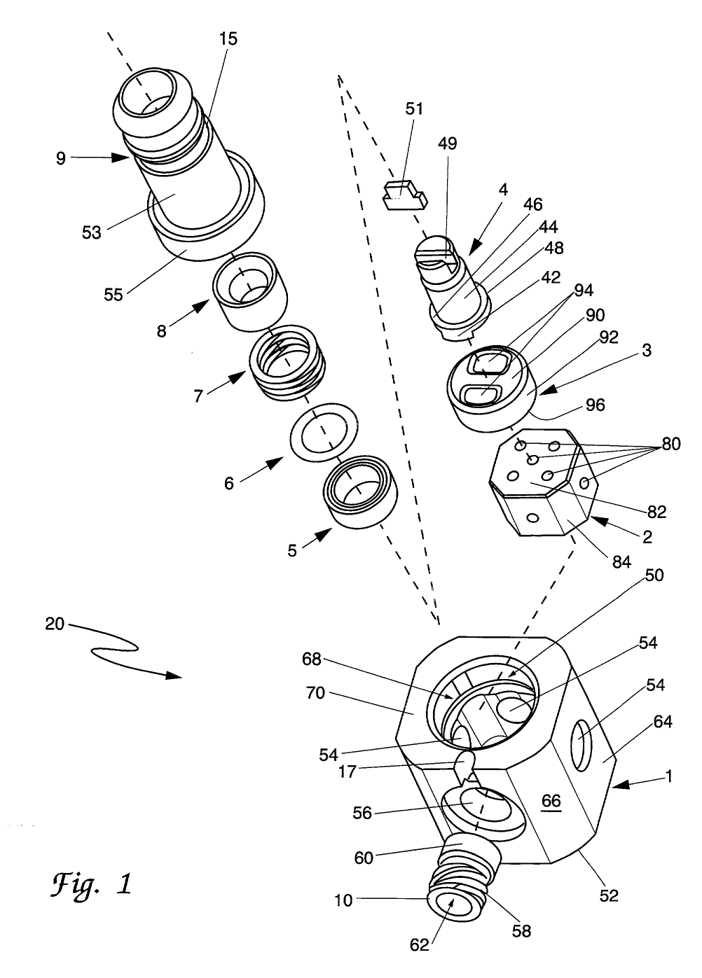

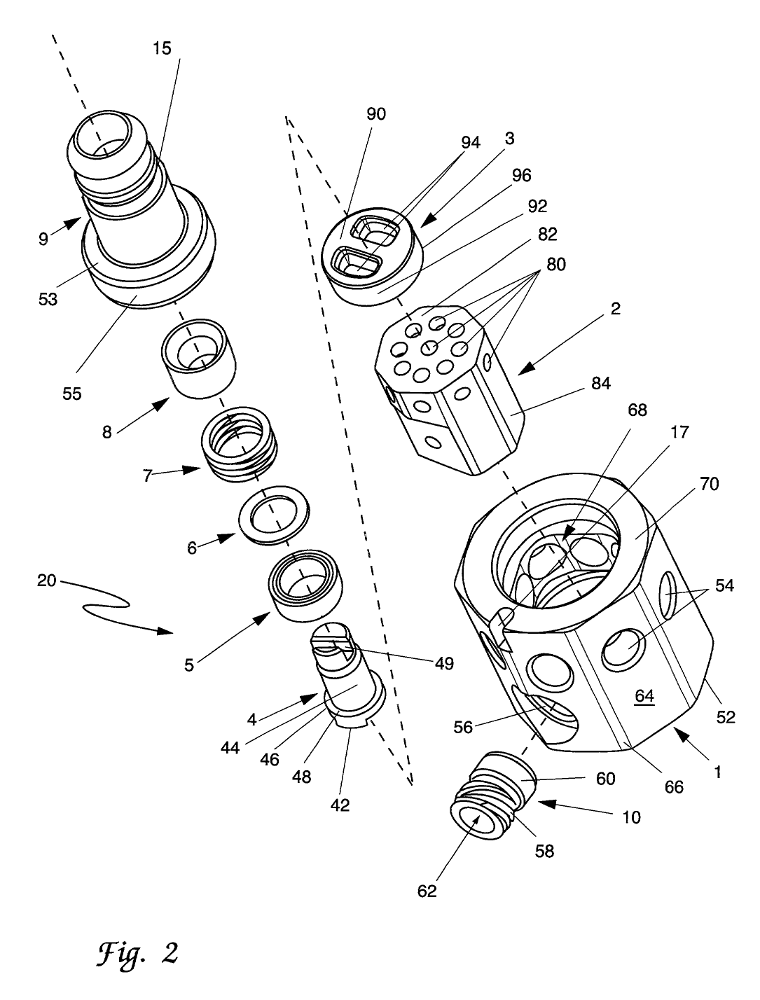

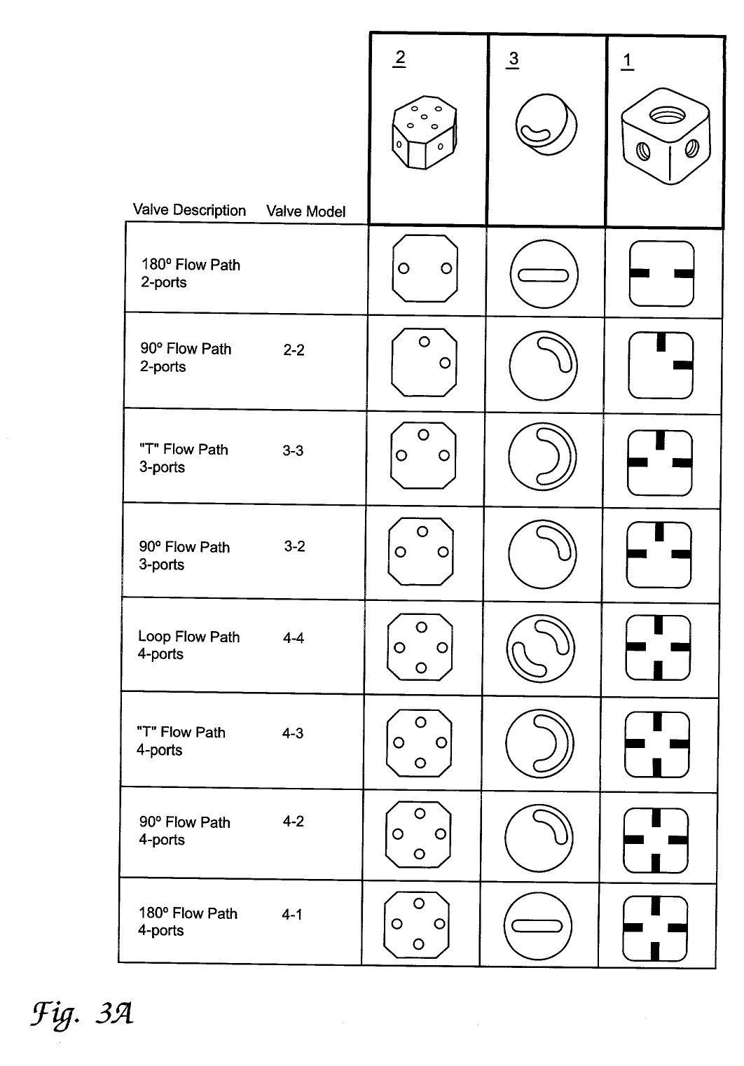

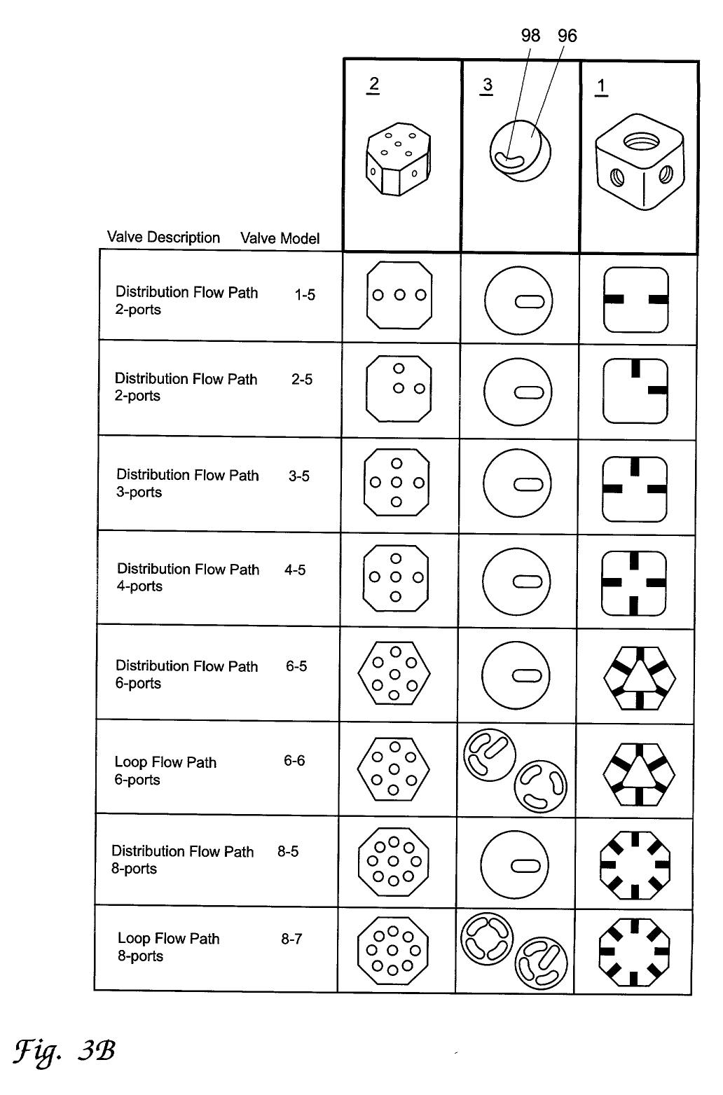

The heart of the valve 20 has ten components, shown in their sequence of assembly by a dotted line in FIGS. 1 and 2. FIGS. 3A and 3B show further variations of three of the ten components: the housing 1; insert 2; and disc gate 3. These variations are illustrative and not exhaustive.

Housing 1 is a hollow polyhedron having an open top 68 and circumscribing flange 70. The hollowed portion includes its interior 50. The housing preferably has a closed bottom wall 52. Plural sides 64 are provided with plural portals 54. In some variation (e.g. FIG. 1) some sides 66 have no portal. One portal 56 may receive a cylindrical “femleg” coupling 10 or other fluid transfer instrument, such as tubing, a syringe, etc. Coupling 10 has an exterior thread 58 at one end and an (optionally unthreaded) annulus 60 at another exterior end. Annulus 60 may be press fit into portal 56 or can be provided with threads in a threaded portal 56. The coupling 10 is hollow with a cylindrical passage 62 which allows fluid to pass there through, into and out of the housing 1. FIGS. 1, 2 and 3 show various contours of the housing 1 and various flow path possibilities in conjunction with differing insert 2 geometry and disc gate 3 geometry. In FIG. 3, housings having sides 64 with portals 54 illustrate 2 through 8 portals. Insert 2 is a polyhedron shaped substantially complemental to its housing 1. Thus, if the housing has four portal bearing sides, so does the insert, typically. Insert 2 is made from ceramic.

Insert 2 has a plurality of passageways 80 extending through its body, from a top 82 to sides 84. As mentioned, it is preferred the passageways of the sides 84 match with the portals 54 and 56 to allow fluid flow. FIGS. 1 through 3 show various passageway patterns for the top 82 of the insert 2. The top passageways coact with disc gate 3.

FIGS. 1 and 2 show the top 90 and side 92 of the disc 3. Top 90 has two recesses 94. These recesses coact with prongs 42 on drive stem 4 to rotate disc 3 to gate fluid between passageways 80 on top 82 of insert 2. The bottom face 96 is depicted in FIG. 3 to illustrate variations in the geometry of a relief channel 98 formed on the bottom face 96. Basically, channel 98 is either an elongate linear oval or a “kidney”-shaped curved oval. Linear ovals typically are radially deployed allowing fluid flow between a central passageway 80 and a peripheral passageway on the top 82. Kidney-shaped, curved ovals typically allow fluid flow between the peripheral passageways 80 on the top 82. These relief channels 98, as a consequence determine which of the passageways 80 on the sides 84 and top 82 receive fluid since a respective one peripheral passageway 80 on the top 82 is in fluid communication with an adjacent corresponding side passageway 80 on its immediate side 84. As mentioned, each side passageway registers with a portal 54 or 56 for fluid through passage.

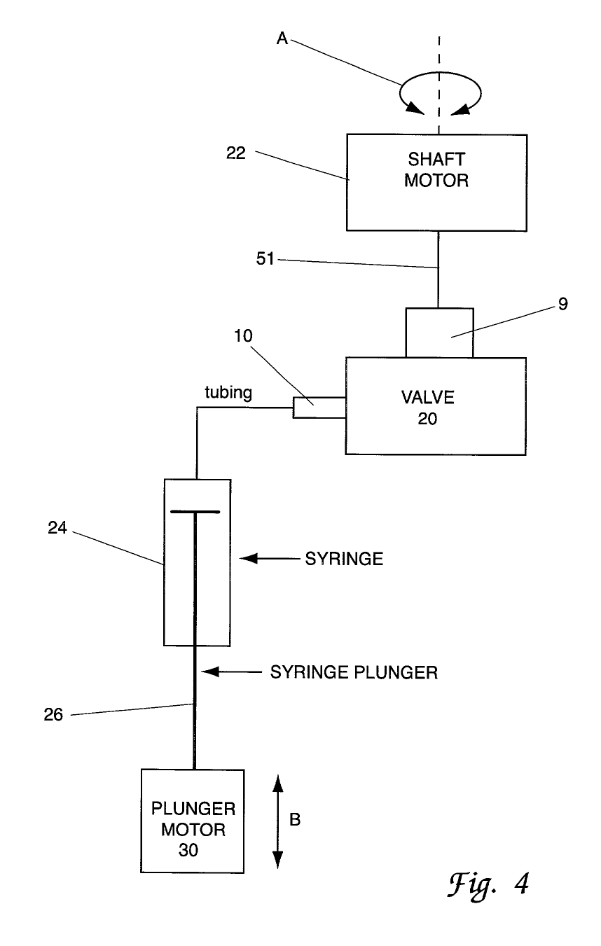

Drive stem 4 has a somewhat cylindrical body 44. The prongs 42 are supported on an enlarged end 46 having a radially extending shelf 48 at the juncture with body 44. The top of drive stem 4 is slotted, providing a key way 49 to be driven by a blade 51 carried on an external driver which meshes into key way 49. The drive stem 4 is driven by a key way blade 51 carried by a shaft of motor shown in FIG. 4 which extends through a hollow of shaft 9 rotating the disc gate 3 feeding various passageways 80 and therefore portals 54, 56. Shaft 9 has a necked-down, cylindrical upper end 53 The shelf 48 in conjunction with an enlarged lower end 55 of shaft 9 allows the serial stacking of a ball bearing 5, bearing riser 6, spring 7 and an upper bearing 8 as shown in FIGS. 1 and 2 with stem 4 next to bearing 5, next to riser 6, followed by spring 7 and bearing 8 and lastly shaft 9.

In a preferred use, FIG. 4 shows a shaft motor 22 rotating driving stem key way 49 with key 51 rotating stem 4 about arrow “A”. Valve 20 is coupled via femleg coupling 10 to a syringe 24 having a plunger 26 which linearly reciprocates along arrow “B” via plunger motor 30.

Disc 3 serves as a gate to insert 2 and is in tight placement there against by virtue of spring 7 and the close tolerance fit of the end 55 of shaft 9 within the flange 70 of housing 1 which is preferably threaded. Insert 2 is made of aluminum oxide (“alumina”). Preferably, it is substantially pure. Insert 2 is thus formed from ceramic. Disc 3 can also be made of ceramic, however, it can also be made of other materials, such as plastic, Teflon-filled amalgams, etc. Disc 3 could be a laminate with a ceramic on bottom surface 96 and in relief 98. The housing can be aluminum, stainless steel, PEEK, etc.

One consequence of the ceramic is that fittings (e.g. coupling 10) can be tightened down very tightly, preventing leaks. Heretofore, non-ceramic inserts were susceptible to distortion in the presence of high torqueing on fittings. This problem caused leaks which do not exist when practicing the present invention.

Note that shaft 9 includes circumferential grooves 15 and that housing 1 has a notch 17. The grooves 15 couple to the driver housing. Notch 17 diverts any weeping of fluid thereat. Weeping can be used to signal it is time to clean (in a solvent) the ceramic insert 2 and/or disc 3, should it be made of ceramic.

Moreover, having thus described the invention, it should be apparent that numerous structural modifications and adaptations may be resorted to without departing from the scope and fair meaning of the instant invention as set forth hereinabove and as described hereinbelow by the claims. For example, the features of this system accommodate the valve(s) with pumps and reservoirs, syringes per se, and in sampling and transferring metered amounts of fluids. Furthermore the valve allows replacement of a multiplicity of elements as shown in FIGS. 3A and B. This allows system reconfigurations and component repair from inventory, which is unknown in the prior art. Heretofore the inserts and discs required custom machining and fitting.

We claim:

1. A valve for use in clinical, analytical or industrial laboratories, comprising, in combination:
a housing having fluid inlet means and fluid outlet means,
an insert interposed between said fluid inlet means and said fluid outlet means, said insert formed from ceramic material, and
means to control transfer of fluid between said inlet means and said outlet means,
said ceramic insert substantially chemically inert to most fluids in the clinical, analytical or industrial laboratory.

2. The valve of claim 1 including a gate having a top surface with drive means there on, and a bottom surface with fluid directing means there on, said gate bottom surface adjacent said insert whereby said drive means orients said directing means relative to said insert.

3. The valve of claim 2 wherein said insert is interposed between said gate and said fluid inlet and outlet means, said insert provided with passageway means which extends from said housing to said bottom surface of said gate.

4. The valve of claim 3 wherein said passageway means are disposed on a side and top of said insert and said top of said insert abuts said bottom of said gate.
